(19) United States
(12) Patent Application Publication
(10) Pub. No.: US 2023/0266989 A1
(43) Pub. Date: Aug. 24, 2023

(54) DISTRIBUTED APPLICATION TESTING IN CLOUD COMPUTING ENVIRONMENTS

(71) Applicant: NVIDIA Corporation, Santa Clara, CA (US)

(72) Inventors: Jim van Welzen, Sandy, UT (US); Matthew Steven Copeland, Sacramento, CA (US); Sylvain Trottier, Dorval (CA); Jonathan White, Fort Collins, CO (US); Masood Shaikh, Pune (IN); Vishweshwar Hiremath, Pune (IN); Shivram Vishwanath Latpate, Pune (IN); Pierre Gervais, Blainville (CA)

(21) Appl. No.: 17/680,221

(22) Filed: Feb. 24, 2022

(51) Int. Cl. G06F 9/455

(52) U.S. Cl. CPC G06F 9/45558; G06F 9/45545; G06F 2009/4557; G06F 2009/45575

(57) ABSTRACT

Apparatuses, systems, and techniques for test an application in a cloud environment. A method can include selecting an application hosted at a virtualized computing environment of an application hosting platform for a test session. Method further includes selecting a set of users associated with the application hosting platform to execute the application during the test session, select a set of observers associated with the application hosting platform to monitor the set of users. The method further includes initiating the test session, authenticating the set of users, causing content data corresponding to the application to be streamed to a user device of each user. The method further includes causing a video stream of the test session to be transmitted to a user device of a corresponding observer for presentation in a observer graphical user interface (GUI), the video stream reflecting interactions of the user with the content of the application.

### TECHNICAL FIELD

At least one embodiment pertains to platforms used to perform and facilitate distributed testing of software application in cloud computing environments. For example, at least one embodiment pertains to systems used to provide and enable a coordinator or developer to securely test a software application hosted by an application hosting platform, according to various novel techniques described herein.

### BACKGROUND

Software applications are tested before released to finalize builds and make adjustments based on feedback if necessary. Some developers can perform testing by having users (e.g., testers) use the software application and provide feedback. Developers can perform testing in-person or onsite. The user can be brought to a secure testing facility to ensure the software application is tested and the pre-release build of the application does not leak and so developers of the software application can observe the users-e.g., observe the users facial, bodily, vocal reaction, etc., to the software application. However, in person testing can include additional costs such as purchasing and maintaining equipment. Additionally, the pool of potential users can be limited based on the geographic location of the testing site. This can make testing more difficult overall.

### BRIEF DESCRIPTION OF DRAWINGS

Various embodiments in accordance with the present disclosure will be described with reference to the drawings, in which:

FIG. 1 illustrates a block diagram of an example cloud computing environment system architecture, in accordance with at least some embodiments.

FIG. 2 illustrates a block diagram of a testing cloud environment, in accordance with at least some embodiments.

FIG. 3 illustrates a block diagram of a testing microservice, in accordance with at least some embodiments.

FIG. 4 illustrates a diagram of an example of streaming a test session to observers, in accordance with at least some embodiments.

FIG. 5 illustrates a diagram of an example of replaying a test session to observers, in accordance with at least some embodiments.

FIGS. 6A and 6B illustrate block diagrams of an example graphical user interface, in accordance with at least some embodiments.

FIG. 7 illustrates example flow diagram illustrating a method for testing a software application in a cloud environment, in accordance with at least some embodiments.

FIG. 8 illustrates a computer system, in accordance with at least some embodiments

FIG. 9 illustrates a computer system, in accordance with at least some embodiments.

### DETAILED DESCRIPTION

Universal principles of software application development typically include significant testing (e.g., user, stress, security, etc.) before they are released. For example, a developer of an application may test certain builds or aspects of their application and use the testing to further develop the application-e.g., modify the application based on the testing conducted. The application can be a gaming application (e.g., a video game or mobile game). In such examples, the developers can have certain users (e.g., testers) play the application and provide feedback. For example, developers can give users a pre-release build and monitor how the user is playing the game in certain situations in order to make improvements-e.g., the developers of an application can monitor users to determine whether the user is entertained or sufficiently challenged by the software application while ensuring the software application does not frustrate the user. Additionally, developers can provide different builds to different users to determine which one is more optimal. To avoid the application being leaked to public users (e.g., users other than those selected for testing) or for the application to be accessible before it is ready, developers can apply certain measures to ensure the testing is performed securely. Traditionally, developers can restrict the testing to being performed in-person or onsite. For example, developers can bring in users to a secured facility in order for the user to play and test the application. Once at the facility, the developers can monitor the user playing the game and also ensure the pre-release build does not leave the building. For example, developers can monitor a user’s emotional response (e.g., satisfaction, happiness, frustration, etc.) to the software application by bringing in the user to the secure facility-e.g., the developers monitor the user themselves in addition to the contents of the software application. In some examples, performing in-person testing can present logistical challenges. For example, in-person testing can cause developers to provision and maintain equipment (e.g., computing devices (e.g., computers, gaming console, mobile phone, smart phone, etc.), surveillance equipment (e.g., webcams, cameras, etc.)) and facilities (e.g., rooms where users can test the application). Additionally, because the testing is in-person, the user has to either live close to a testing facility or travel to it-thereby potentially limiting the pool of available testers or requiring the maintenance of multiple, distributed testing facilities. This can effectively limit the number of different types of users that can test a specific application-e.g., users from different cities or countries. In some examples, traveling to the site can also be restricted or impossible due to external circumstances-e.g., developers can be unable to bring users to the testing facility. In some embodiments, the in-person testing can also present logistical challenges for observers of the test session-e.g., observers or contributors of the game can be located in any location and having in-person testing can present logistical challenges to ensure each observer is brought to the in-person testing.

Implementations of the present disclosure address the above and other deficiencies by virtualizing aspects of application testing using a cloud environment. For example, an application hosting platform can facilitate scheduling of test sessions, provide secure access to an application for a selected number of users, and monitor and observe the users to improve the application. For example, a developer can upload a pre-release build of the application to the application hosting platform securely. A user accessing the application for testing can be provided with the stream of the application’s content (without having to download the application build at the user’s location), which allows the application hosting platform to ensure that the application build can be tested securely. Additionally, the application hosting platform can include a database that stores the application and other information associated with testing the application that can be modified by a coordinator (e.g., a person overseeing the testing of the application for the developer). For example, the application hosting platform can include software or architecture (e.g., a microservice) that enables the coordinator to select users for the testing of the application, a time to start a test session, a time to end the test session, a build of the application to test, and select observers to monitor the testing of the application. For example, the coordinator can select a list of users associated with the application hosting platform to test the application. In such examples, the users from the list can be provided with access to the application during the test session period-e.g., the application will otherwise be unavailable to the users to ensure the testing is secure. The coordinator can be allowed to assign which builds a specific user will be testing as well as a list of people to observe the test session. In such examples, the application hosting platform can provide user and application information to the observers-e.g., which user they are observing along with which build the respective user is testing. That is, the application hosting platform can allow the coordinator to organize the entire test session in a cloud environment-e.g., from which users can test the application to which people will observe.

In some examples, the application hosting platform can include or be associated with architecture that enables testing of the application in a cloud environment. Such architecture can include one or more computer systems each hosting one or more virtualized computing environments (e.g., virtual machines or containers) running on top of a hypervisor or a host operating system. For example, the application hosting platform can request that the application be executed (e.g., launched and loaded) at a virtualized computing environment (e.g., a virtual machine or a container). By executing the application at the virtualized computing environment, the content of the application can be streamed to a user computing device. Contents of the application can also be stored at the application hosting platform, and provided to an observer computing device-e.g., a copy of the stream displayed to the user can be viewed by the observer as well via a graphical user interface (GUI) provided by the application hosting platform. The application hosting platform can also obtain user inputs (e.g., which controls a user is using at a given time while interacting with the application). For example, the application hosting platform can receive data specifying which buttons on a controller a user presses while playing a software application. The application hosting platform can also request to create a stream (via a webcam) of the test session to show reactions of the user to the observer. Additionally, application hosting platform can provide a GUI that enables the developer to provide scope on what moments of the application should be closely monitored by the observers-e.g., the developer can provide inputs defining what event the observers should focus on. For example, the application hosting platform can provide an observer GUI that enables the developers or observers to annotate and timestamp events (e.g., user entered a first level when the software application is an example of a gaming application) from each session as well as allow the recorded stream to be indexed and accessed afterwards-e.g., the observer can search for all times a user utilized an item within the software application.

In some examples, the observer can see a stream of the test session via an observer GUI, where the stream is stored at the application hosting platform (e.g., at a database or any other data store). For example, the observer GUI can present a stream for each test user that includes a stream of their application, their webcam, and their inputs. Accordingly, the observer can select which user to observe via the observer GUI. Additionally, the observer can choose to see other information relevant to the testing-e.g., frame rate performance, spatial representation (e.g., where on a map of a software application the user is), analytics associated with the application, temporal representation (e.g., a timeline tagged with events of the software application), etc. In some embodiments, the observer can also annotate the stream-e.g., look for particular events, create clips, mark particularly challenging moments of a software application, etc. In some embodiments, the application hosting platform can store a recorded stream of the test session at a data store and allow the selected observers to review the stream at subsequent time. In such embodiments, the recorded stream can included the annotations (e.g., metadata captured associated with events) and enable filtering and searching of recorded stream using the metadata as the search/filter criteria.

Accordingly, the described technology including the above software, architecture, and GUIs allows a developer to test their application within the cloud environment. This can enable the developer to select users from anywhere at any time in lieu of in-person testing. Because the content of the application is streamed (e.g., the application build is not downloaded locally), the application can be provided to users securely while also allowing the observer to observe the entire execution of the application via the observation GUI. Accordingly, logistical challenges related to the testing of the application can be reduced in the cloud environment.

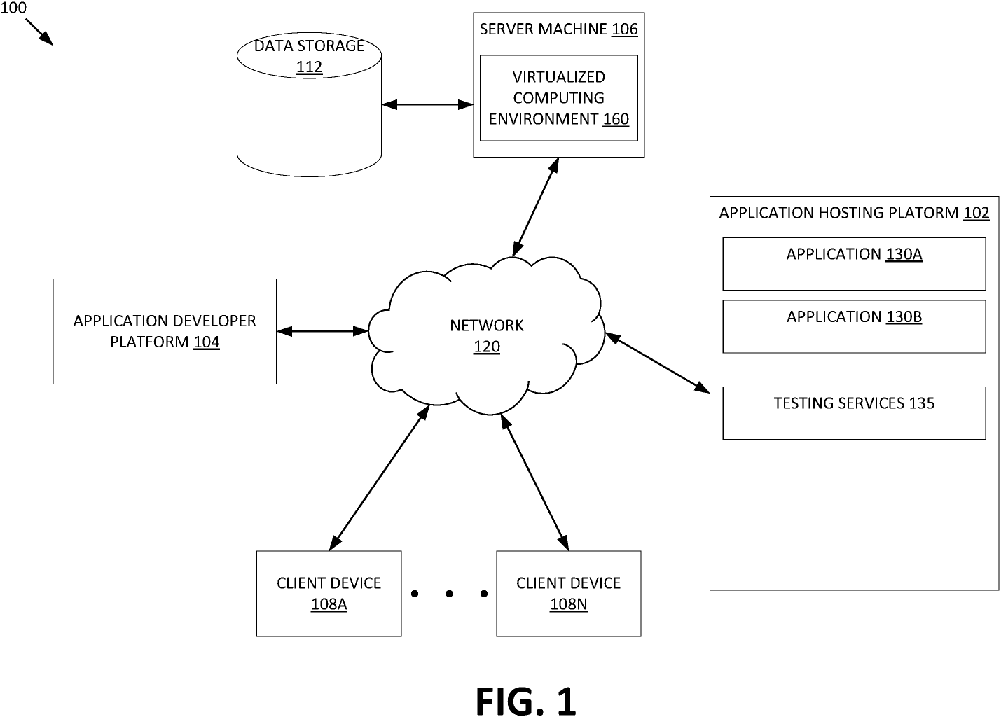

FIG. 1 illustrates a block diagram of an example system architecture 100, according to at least one embodiment. The system architecture 100 (also referred to as “system” herein) includes application hosting platform 102, application developer platform 104, server machine 106, client devices 108A-N (collectively and individually referred to as client device(s) 108), and data storage 112, each connected to a network 120. In implementations, network 120 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

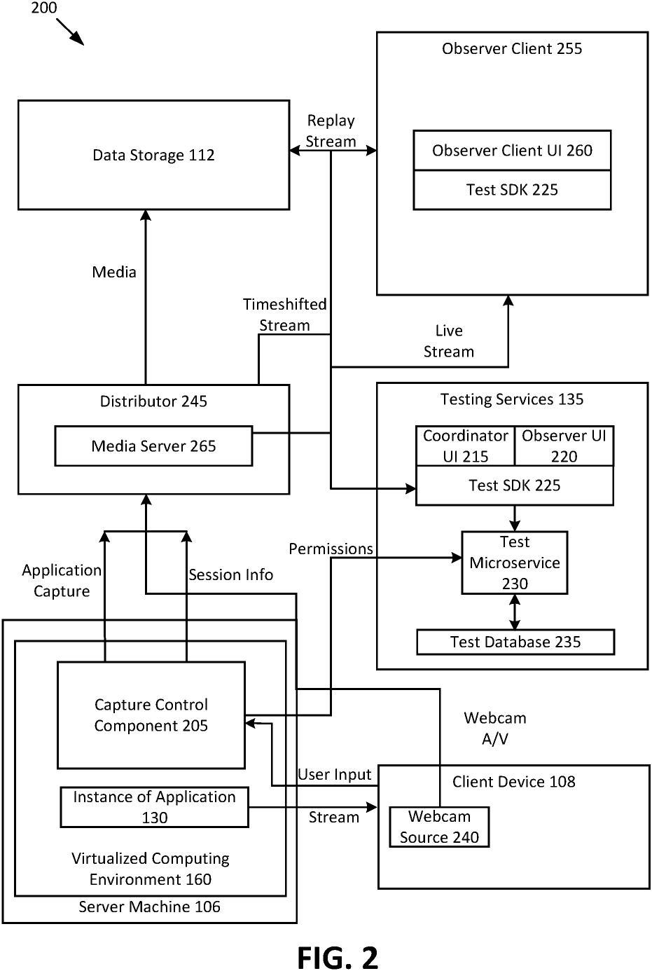

In some implementations, data storage 112 is a persistent storage that is capable of storing content items as well as data structures to tag, organize, and index the content items. Data storage 112 may be hosted by one or more storage devices, such as main memory, magnetic or optical storage based disks, tapes or hard drives, NAS, SAN, and so forth. In some implementations, data storage 112 may be a network-attached file server, while in other embodiments data storage 112 may be some other type of persistent storage such as an object-oriented database, a relational database, or any other data store, that may be hosted by platform 102 or one or more different machines coupled to the platform 102 via network 120. In some embodiments, data storage 112 is capable of storing content related to application 130. For example, data storage 112 can store streaming instances of application 130, user inputs from client device 108, metadata, and other information related to a test session as described with reference to FIG. 2.

Application hosting platform 102 may be configured to host files of one or more applications (e.g., application 130A, application 130B, etc.) provided by an application developer (e.g., via application developer platform 104). Application developer platform 104 may be used by an application developer (e.g., a user, company, organization, etc.). For example, an application developer may be a video game developer that develops a video game (represented by an application 130) for users to interact with on client devices 108. Application hosting platform 102 may provide users with access to an application 130 (or an instance of an application 130) provided by application developer platform 104 via a respective client device 108A-N. For example, application hosting platform 102 may allow users to consume, upload, download, and/or search for applications 130. In one or more embodiments, application hosting platform 102 may include a cloud-hosted collaborative content creation platform that allows multiple developers or multiple representatives of the same developers to create, merge, develop, refine, modify, simulate, render, illuminate, and animate -- as non-limiting examples of content creation tasks, generally -- for two- and three- dimensional assets for applications 130. In some embodiments, application hosting platform 102 may have a website (e.g., one or more webpages) or a client application or component that may be used to provide users with access to applications 130. In some embodiments, each application 130 may consist of generic data 132 (e.g., data exclusive of user data) and user data 134—e.g., generic data 132A and user data 134A of application 130A, generic data 132B and user data 134B of application 130B, etc.

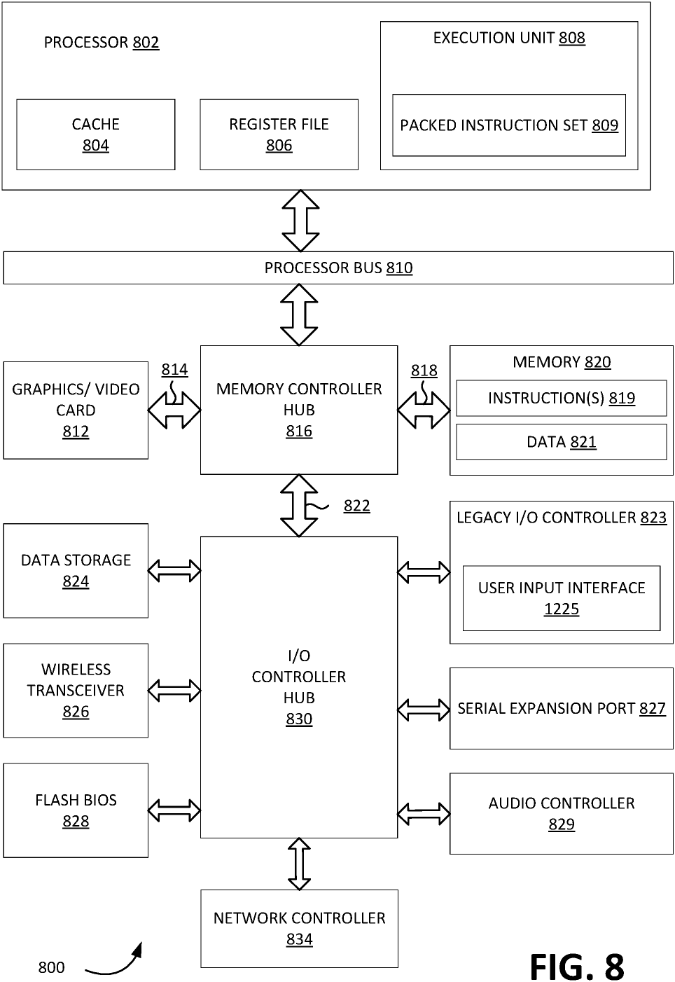

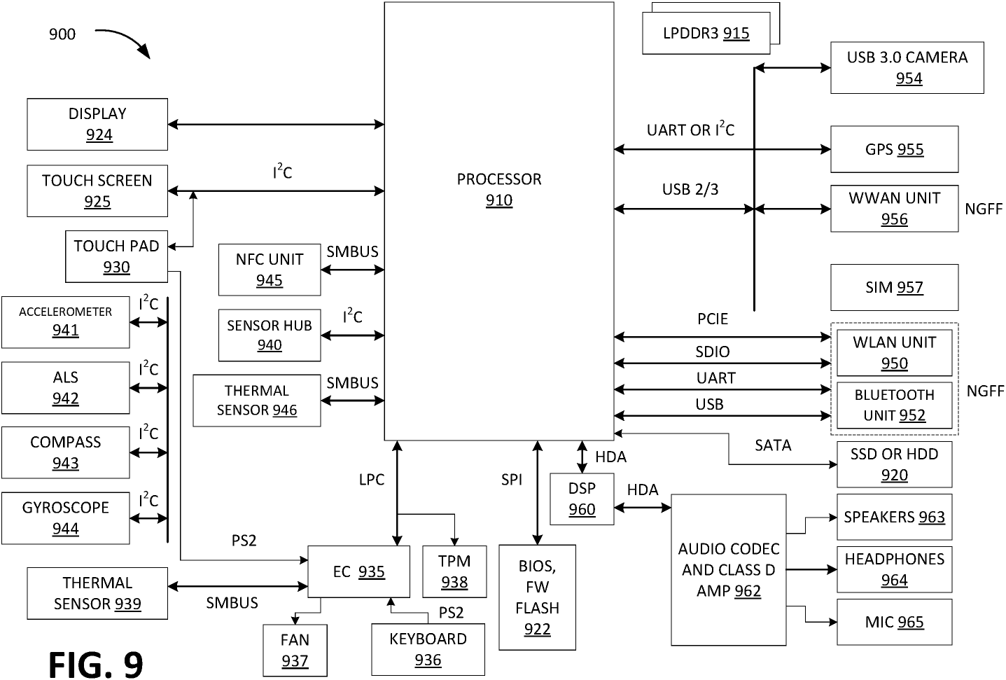

In some embodiments, server 106 may host a virtualized computing environment 160 running an instance of application 130. For example, server 106 may be a computer system that includes one or more physical devices (e.g., a processing device (e.g., a GPU), memory, one or more I/O devices, etc.) and a hypervisor and/or a host operating system that manage one or more virtualized computing environments 160. A virtualized computing environment 160 may correspond, for example, to a virtual machine running a guest operating system and one or more guest applications including an instance of application 130, or a container running an application such as an instance of application 130. One or more servers 106 may be provided and each server 106 may host one or more virtualized computing environments 160. In some embodiments, each server 106 or any other server of the application hosting platform 102 may correspond to computer system 800 and/or computer system 900 described with respect to FIGS. 8 and 9.

The virtualized computing environment 160 may be instantiated to facilitate execution of the instance of the application 130 for access by client device 108 and may be deconstructed after a termination of the application instance as requested by a user of client device 108, in accordance with embodiments provided herein. For example, a user accessing the application instance via the application hosting platform GUI on client device 108 may log out of an account associated with application 130 hosted by application hosting platform 102. When it is detected that the user has “logged out” of the associated account, application hosting platform 102 may transmit a deconstruct request to server 106, which may cause a hypervisor to deconstruct virtualized computing environment 160.

A user of a respective client device 108 may engage with (e.g., consume, interact, etc.) the application 130 (e.g., via the application hosting platform GUI) to progress through the application via the respective client device 108. In an illustrative example, applications 130A and 130B may be video game applications (e.g., software applications) developed by a video game developer. The client devices 108 may include devices, including but not limited to: televisions, smart phones, cellular telephones, personal digital assistants (PDAs), portable media players, netbooks, laptop computers, electronic book readers, tablet computers, desktop computers, set-top boxes, software consoles, and the like. As discussed above, the individual client devices 108 may include a client component of the application hosting platform 102 (or a web browser) that provides a GUI allowing a user of client device 108 to request execution of application 130. The GUI may provide a rendered version of the application 130 for presentation during a runtime of the application 130 and allow the user to provide input during the runtime of the application 130.

In some embodiments, server machine 106 can be separate from a serve machine that supports application hosting platform 102. In other embodiments, server machine 106 can be part of the application hosting platform 102. In some embodiments, one or more server machines 106, application hosting platforms 102, application developer platforms 104, and data stores 112 can be part of a cloud environment that can be accessed by client devices 108A-N via network 120.

Application hosting platform 102 can include testing services 135. In some embodiments, application hosting platform 102 can facilitate a test session for application 130-e.g., for a software application 130. For example, testing services 135 can include a microservice that a coordinator (e.g., developer) can utilize to create and initiate test sessions. In some embodiments, the coordinator can select users to test a pre-release build of application 130, select observers (e.g., developers) to monitor the test session, and initiate the test sessions. Users of client devices 108 can access the test sessions and test an instance of the pre-release build of application 130 via the virtualized computing environment 160. In at least one embodiment, testing services 135 can cause a recording of the test session to be stored at data storage 112 or another media server. Accordingly, observers can access the test session via their respective client devices 108 at a subsequent time. Additional details regarding the testing service 135 are described with reference to FIG. 2.

FIG. 2 illustrates a block diagram of a cloud environment 200, according to at least one embodiment. In some embodiments, cloud environment 200 includes server machine 106, client device 108, data storage 112, testing services 135, distributor 245, and observer client 255. In some embodiments, server machine 106, client device 108, data storage 112, testing services 135, distributor 245, and observer client 255 can be connected via a network 120 as described with reference to FIG. 1. In some embodiments, the testing services 135 can include a coordinator UI 215, observer UI 220, test software development kit (SDK) 225, test microservice 230, and test database 235. The virtualized computing environment 160 can include an instance of application 130 and a capture control component 205. In some embodiments, the observer client 255 can include an observer UI 260 and test SDK 225.

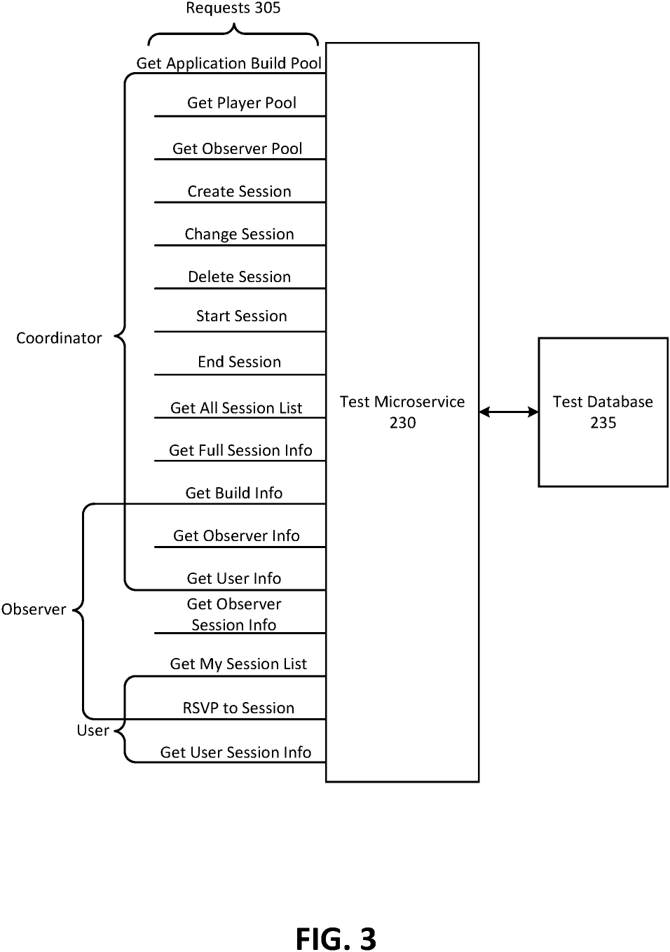

In at least one embodiment, testing services 135 can be configured to allow a developer (e.g., coordinator) to create and initiate a test session for a software application 130. For example, the testing services 135 can provide a graphical user interface (GUI or Coordinator UI 215) that enables the coordinator to create test sessions for pre-release builds of a software application 130. In at least one embodiment, the coordinator can upload or register pre-release builds to the test database 235—e.g., the coordinator can upload multiple pre-release builds for the software application 130 to test various features and events. Subsequently, the coordinator can access the coordinator UI 215 to create a test session for one of the pre-release builds, select users (e.g., testers) from users of the application hosting platform 102 to test the selected pre-release build, and select observers to monitor the users testing the software application 130. In at least one embodiment, the coordinator can select times for the test session. In such examples, users selected can access the instance of application 130 for the selected times of the test session-e.g., the software application 130 can be securely tested as it is available to the users during the test session and unavailable otherwise. In some embodiments, the testing microservice 230 (e.g., a microservice architecture) can facilitate requests selected by the coordinator, an observer, or a user by accessing the test database 235 and causing the content to be displayed at the coordinator UI 215, the observer UI 220, or the user GUI at the client device 108 as described with reference to FIG. 3. In some embodiments, once the coordinator has created and initiated the test session, users can access the instance of the software application 130 and observers can monitor the testing. In at least one embodiment, the testing services 135 is integrated with a designated test software development kit (SDK) 225 (e.g., an application hosting platform (AHP) application programming interface (API) plugin) that can be configured to communicate with a user of client device 108, a coordinator, or an observer of observer client 255 via a predefined set of API commands to launch test sessions. In some embodiments, application hosting platform 102 (e.g., testing services 135) can have a unique test SDK 225 for each software application 130 it hosts. Alternatively, a common test SDK 225 can be operable with all software applications hosted/registered with the application hosting platform 102.

In some embodiments, virtualized computing environment 160 can be configured to run an instance of application 130. For example, virtualized computing environment 160 can be configured to run an instance of the pre-release build of software application 130 selected by the coordinator for the test session. In at least one embodiment, contents of the instance of application 130 can be streamed to a user of client device 108. In some embodiments, the virtualized computing environment 130 can receive user input from a user of the client device 108 accessing the instance of the software application 130. For example, a capture control component 205 of the virtualized computing environment 160 can receive information such as which buttons a user is pressing on a controller or keyboard while progressing through the instance of the application 130-e.g., how the user is interacting with the software application 130. In at least on embodiment, the virtualized computing environment 160 can be integrated with an events API and a capture API (e.g., SDK) that capture commands and events of the software application 130. For example, a developer can indicate moments of the software application 130 that an observer should focus on for the test session. The events API and capture API can communicate the commands of the software application 130 with the capture control component 205 via a predefined set of API commands indicating events in the software application 130 to closely monitor. For example, the software application 130 can indicate a stream of events representing a log of what is occurring within the software application (e.g., within a gaming application). Accordingly, an observer GUI can notify observers of events while the test session is occurring and enable observers to search for the events after termination of the test session-e.g., search for how often a user utilizes an item in the software application. In some embodiments, the event API can also include debug information. In some embodiments, the capture control component 205 can communicate capture directives (e.g., what to capture from the contents of the instance of the software application 130) and permissions (e.g., what to record and store from the contents of the instance of the software application 130) with the test microservice 130 during the test session. For example, the test microservice 130 can indicate what aspects of the client device 108 will be recorded/stored-e.g., gameplay, camera, microphone, keystroke permissions. In some embodiments, the virtualized computing environment 160 can send the application capture (e.g., the captured content of the instance of the software application 130) and session information to a distributor 245. In at least one embodiment, the session information can include user inputs, capture filters, and information about the software application 130 (e.g., the pre-release build of the software application 130 utilized in the test session).

In some embodiments, the client device 108 can include a webcam source 240-e.g., a built in webcam or an external webcam used by a user of the client device 108. In some embodiments, the webcam source 240 can record the user during the test session-e.g., record the user while the user is playing the software application 130. For example, the webcam source 240 can record reactions of the user while the user interacts with the software application 130 during the test session. In at least one embodiment, the audio/visual feed (e.g., webcam A/V) of the webcam source 240 can be sent to distributor 245.

In some embodiments, distributor 245 can be configured to receive application capture, session information, and webcam A/V. In at least one embodiment, distributor 245 can include a media server 265 (e.g., a media streaming server) that receives the application capture, webcam A/V and session information. For example, the media server 265 may be a computer system that includes one or more physical devices (e.g., a processing device (e.g., a GPU), memory, one or more I/O devices, etc.) and a hypervisor and/or a host operating system that manage the application capture, webcam A/V and session information. In some embodiments, the media server 265 can store the information in a cloud computing environment. In such embodiments, the media server 265 can be integrated with a cloud storage API plugin. In at least one embodiment, the media server 265 can transmit a live stream of the test session to an observer utilizing the observer client 255—e.g., a live stream for each user testing the software application 130 during the test session can be transmitted to the observer client 255. In some embodiments, the distributor 245 can include a digital video recorder (DVR) that can time shift the live stream-e.g., a time shifted stream can be transmitted to the observer using the observer client 255. In at least one embodiment, the DVR can enable the observer to pause, rewind, fast forward, or otherwise manipulate the live stream during the test session. In at least one embodiment, the distributor 245 can transmit the media (e.g., the application capture, webcam A/V and session information) to data storage 112.

In some embodiments, data storage 112 can be configured to store media (e.g., the application capture, webcam A/V and session information) for a respective test session. In some embodiments, the data storage 112 can store every test session associated with a software application 130-e.g., all test sessions associated with every pre-release build of the software application 130. In some embodiments, the data storage 112 can be configured to transmit a replay of the stream of the test session to the observer client 255.

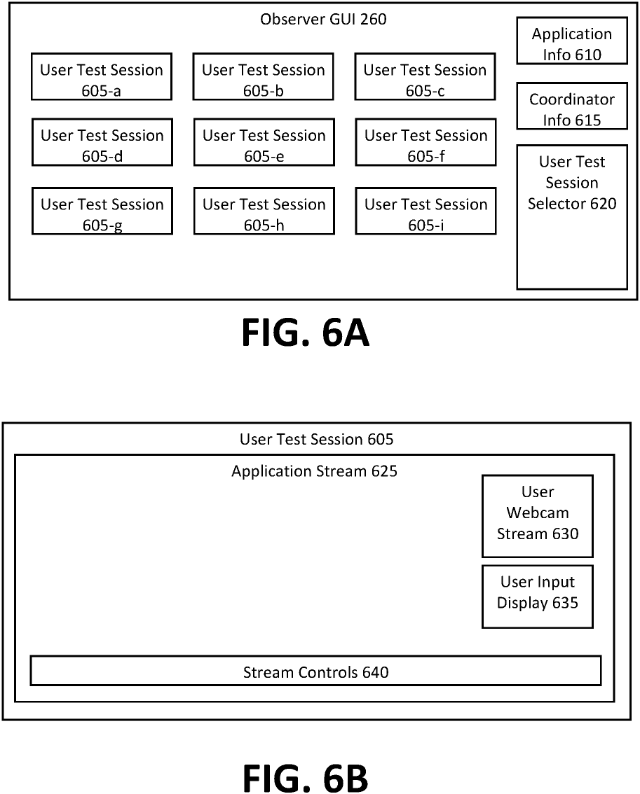

In some embodiments, observer client 255 can be configured to display a live stream, a time shifted stream, or a replay stream of a test session to an observer. In at least one embodiment, the observer client 255 can include an observer client UI (e.g., GUI) 260 that enables an observer to watch and interact with a stream of the test session. FIG. 6 illustrates an example of content streamed to an observer client 255 during a test session. In some embodiments, the observer client 255 can be integrated with a test SDK 225 that can be configured to communicate the live stream to the observer. In at least one embodiment, the test SDK 225 can enable the observer to manipulate the stream during the test session-e.g., pause the stream, replay the stream, rewind the stream, fast forward the stream, annotate the stream, search within the streams, filter the streams, etc. In some embodiments, the observer can access a replay of the stream of the test session after the test session has ended. By utilizing cloud environment 200, a developer can securely test a pre-release build of a software application 130.

FIG. 3 illustrates an example block diagram of testing services 135, in accordance with at least one embodiment. For example, testing services 135 can include test microservice 230 and test database 235. In at least one embodiment, a user can access test microservice 230 via a user GUI as described with reference to FIG. 2. In some embodiments, a coordinator and an observer can access the test microservice 230 via the coordinator UI and observer UI, respectively, as described with reference to FIG. 2.

In at least one embodiment, test microservice 230 can allow a developer to create and initiate a test session for a pre-release build of software application 130 as described with reference to FIG. 2. In such examples, the test microservice 230 can allow a coordinator, observer, or user (e.g., tester) to make requests 305 for information. In some embodiments, the test microservice 230 (or a different component of the application hosting platform 102) can authenticate (e.g., verify) the access to ensure information stored at the test database 235 is distributed securely to the coordinator, observer, or user. That is, test database 235 can store information that can be accessed only by the coordinator, or only by the observer, or only by the user. In such examples, each person can have a token when they sign into the application hosting platform 102, and the microservice 230 can authenticate the token to ensure the person has permission to access the information stored at the test database 235.

For example, the coordinator can make a request 305 “get application build pool” to access a list of pre-release builds of the software application 130 available (e.g., loaded or registered) at application hosting platform. For example, the developer can upload or register five (5) pre-release builds for a respective application 130. In such examples, the coordinator can make the request 305 “get application build pool” to access the list of five (5) pre-release builds and select one for a test session. In some embodiments, the coordinator can make a request 305 “get player pool” to obtain a list of possible users (e.g., testers) for the test session. In some embodiments, the list of possible users can be all users associated with the application hosting platform 102. In some embodiments, the list of possible users can be filtered based on a preference of the coordinator-e.g., a list of possible users can be filtered to users who play first person shooting games or role playing games (RPG). The coordinator can select a set of users from the list of possible users for the test session based on requesting the “player pool.” In some embodiments, the coordinator can make a request 305 “get observer pool” to obtain a list of all possible observers. Accordingly, the coordinator can select a set of observers from the list of all possible observers for the test session. In some embodiments, the coordinator can make request 305 to “create session,” “change session,” “delete session,” “start session,” and “end session” to create, change, delete, start, or end a test session for the application 130. For example, the coordinator can select a date and time for the test session. In some embodiments, the coordinator can save drafts of future test sessions or view drafts of pending test sessions. In some embodiments, the coordinator can make a request 305 to get build information. For example, the coordinator can access information related to a type of build or build number (along with additional information associated with the build) of the application 130. In some embodiments, the coordinator can make a request 305 “get observer information” or “get user information” to access information about the observer(s) and user(s), respectively. For example, after selecting the set of users and set of observers, the coordinator can make a request “get observer information” or “get user information” to see information on the observers or users selected for the test session-e.g., access their contact information. In some embodiments, user information can include games and genres the user has played, the gameplay frequency of the user, and the proficiency of the user-e.g. user rankings. Accordingly, the microservice 230 enables the coordinator to create test sessions, invite participants, manage the upcoming test sessions, and run the test session when it is active.

In some embodiments, an observer can also make the request 305 “get build information,” “get observer information,” and “get user information.” That is, some information stored at the test database 235 can be accessed by both coordinator and observer or both observer and user. In some embodiments, the observer can make a request 305 to “get observer session information” to access information associated with the observer for the test session-e.g., date and time of test session, length of test session, etc. In some embodiments, the observer can make the request 305 “get my session list” to access a list of all test sessions a respective observer might be observing. That is, an observer can be scheduled to observer multiple test sessions and can make the request 305 “get my session list” to access the list of prior and upcoming test sessions. In at least one embodiment, the observer can make a request 305 “RSVP to session” to accept an invitation to observe a test session sent from the coordinator. Accordingly, the microservice 230 enables observers to look at prior and upcoming test sessions, accept or decline test session invitations, observer test sessions either live or via replay after it is over.

In some embodiments, a user can also make the request 305 “get my session list” and “RSVP to session” to get access to a list of all prior and upcoming test sessions for the user and to accept invitations to test sessions, respectively. In at least on embodiment, the user can make a request 305 to “get user session information” to access information associated with the user for the test session-e.g., date and time of test session, length of test session, name of the software application, etc. In some embodiments, the user can access information about requirements to access the test session (e.g., system requirements or any setup associated with the cloud environment). In some embodiments, the user can request to run a test of their system (e.g., of their client device 108) before the test session date. In at least one embodiment, after request 305 “get my session list,” a user GUI can display times, application names, test session names, coordinator contact information, status of invitation (e.g., is an invitation accepted, declined, pending), etc. Accordingly, the test microservice 230 can enable the user to see upcoming test sessions, enter test sessions, and participate in active test session. In some embodiments, the microservice 230 can enable testing a software application in a cloud environment as it allows coordinators to create and initiate sessions and allows observers and users to accept invitations to test sessions along with getting information regarding the test session.

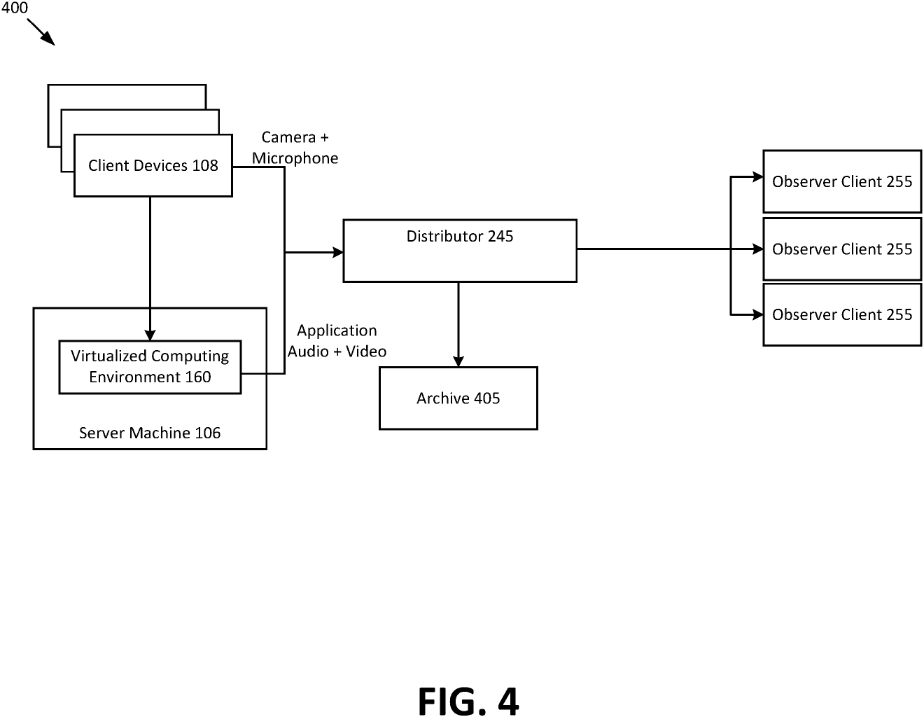

FIG. 4 illustrates a diagram of an example of streaming a live test session to observers, in accordance with at least one embodiment. For example, diagram 400 illustrates client devices of observers observing a live test session of users testing a software application 130. Diagram 400 depicts operations that can be performed by processing logic comprising hardware, software, firmware, or any combination thereof. In at least one embodiment, diagram 400 depicts operations performed by client 108, server machine 106, distributor 245, observer client 255, and archive 405 in a cloud environment 200, as described with reference to FIG. 2.

In some embodiments, after a coordinator has created a test session (e.g., selected a build of a software application 130, selected a set of tasks, scenarios, or conditions to test, selected a set of users, and selected a set of observers for the test session), the coordinator can initiate a test session. In such embodiments, users of client devices 108 can access an instance of the build of software application 130 to be tested during a time the test session is active-e.g., during a time the coordinator has allowed the users to access the software application 130. In at least one embodiment, client device 108 can access the virtualized computing environment 160 to display a stream of the instance of the software application 130 to a respective user of the client device 108. In the example illustrated in FIG. 4, the test session can include three (3) users. In other embodiments, more than or less than three (3) users can be selected. In some embodiments, as the user interacts with the instance of the software application 130, a webcam source 240 can record the user’s reactions as described with reference to FIG. 2. Accordingly, distributor 245 can receive contents of the application (e.g., application audio and video) from the virtualized computing environment 160 and receive video and audio from the webcam source 240 of the client device 108.

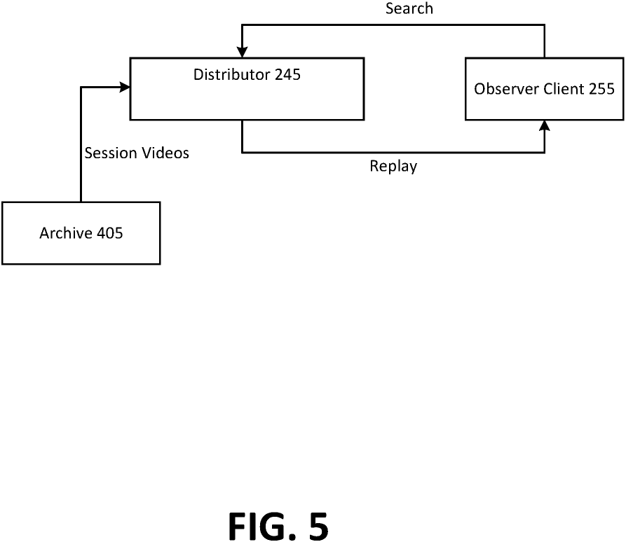

In some embodiments, the distributor 245 can transmit the application audio/video and the webcam audio/video to an archive 405. In some embodiments, archive 405 can be part of data storage 112 as described with reference to FIG. 2. In some embodiments, the stream stored at the archive 405 can be accessed by an observer at a subsequent time as described with reference to FIG. 5. In at least one embodiment, the distributor 245 can also transmit the stream (e.g., the application audio/video and the webcam audio/video) to observer client(s) 255. Although three observer clients 255 are illustrated, in some examples there can be more than or less than three (3) observer clients 255—e.g., the coordinator can select more than or less than three (3) observers to watch the test session.

In some embodiments, an observer can watch a stream of the users testing the software application 130 during an active test session-e.g., via the media server 265 of the distributor 245. In some embodiments, the observers can select what streams to watch via an observer GUI. For example, an observer of client device 255 can select to watch a stream of a first user of a first client device 108, watch a stream of a second user of a second device 108, watch a third user of a third client device 108, or any combination thereof. In some embodiments, the virtualized computing environment 160 can also send notifications to the distributor 245—e.g., observers at the observer client 255 can receive notifications in addition to the streams. In some embodiments, the notifications can be communicated by the events API or capture API as described with reference to FIG. 2-e.g., notifications of events indicated or marked by a developer of the software application 130. In at least one embodiment, the notification can indicate an event (e.g., a boss battle in the software application 130) to the observers. In such examples, the observers can select different views (e.g., different streams) based on the notifications. For example, the observer can switch from watching the first user to the second user after receiving a notification that the second user is encountering an event. In at least one embodiment, the observer can annotate the stream during the test session-e.g., the distributor can also collect observer inputs when they annotate streams. For example, observers can mark time stamps to return to, annotate events that they want to discuss, annotate specific users’ streams they want to rewatch, create clips they will go back to, etc. Additional details regarding the observer GUI are described with reference to FIG. 6.

FIG. 5 illustrates a diagram of an example of streaming a replay of a test session to observers, in accordance with at least one embodiment. For example, diagram 400 illustrates observers observing a replay of a test session of users testing a software application 130. Diagram 400 depicts operations that can be performed by processing logic comprising hardware, software, firmware, or any combination thereof. In at least one embodiment, diagram 400 depicts operations performed by distributor 245, observer client 255, and archive 405 in a cloud environment 200, as described with reference to FIG. 2.

In some embodiments, after a test session is complete, observers can request to watch a replay of a respective test session via the observer GUI and the microservice 230. In such examples, after the observer selects a test session to replay, the distributor 245 can access the archive 405 for the test session video. In some embodiments, the distributor 245 can then stream the replay of the test session to the observer client 255—e.g., the observer can watch the replay via the observer GUI at the observer client 255. In some embodiments, the replay of the stream can include annotations and event notifications as described with reference to FIG. 4. In at least one embodiment, the replay stream can include a timeline of the annotations or events such that the observer can skip directly to the watch the annotation or event. In at least one embodiment, the observer can make further annotations while watching the replay stream. In some embodiments, the observer can share annotations with other eligible observers-e.g., other observers within the set of observers selected by the coordinator. In some embodiments, the observer can select different viewpoints and users to view while watching the replay stream.

In some embodiments, the observer can perform a search of previous test sessions or of recorded test session videos. For example, the observer can access or search analytics from multiple test sessions to compare and understand gameplay of the multiple test sessions-e.g., view frame rate or performance of users during the test session. In some embodiments, the observer can set certain criteria to search for-e.g., search for certain clips, events, and annotations. In some embodiments, the observer can also search for time stamps, for a specific software application, for a specific build of a software application, for specific users, etc. In such examples, the distributor 245 can retrieve the request clips from the archive 405 and stream them to the observer client 255. Accordingly, the observer can more efficiently review test sessions.

In some embodiments, the coordinator can select reviewers to test the software application. In such examples, the reviewers can access the software application during a test session as a user would. In some embodiments, different permissions can be used for reviewer test sessions. For example, the coordinator can arrange the test session so gameplay is recorded but a webcam source of the reviewer does not record video or sound. In some embodiments, the stream of the reviewer (e.g., the gameplay) can be stored at the archive 405. In such embodiments, the developer or coordinator can access the test session video and release it to the reviewer in time for a review.

In some embodiments, the coordinator can create a test session that is a closed beta recording. In such examples, beta-testers agree to be watched over the course of the beta-test-e.g., over the course of time (e.g., 24 hours, days, weeks, or months). In such embodiments, virtualized computing environment 160 can indicate to store the application gameplay, clips of events in the game play (selected by the coordinator) and logs of events happening the test session stream. In at least one embodiment, the observer can access a replay of the beta-test session and search through the stream to find pertinent clips and events. In embodiments where the beta-test lasts weeks or months, the virtualized computing environment 160 can indicate to save content or annotations that match certain criteria or expire (e.g., delete) content after a certain duration based on inputs from the observer or developer.

FIGS. 6A and 6B illustrate block diagrams of an example observer graphical user interface (GUI), in accordance with at least some embodiments. In some embodiments, the observer GUI can be displayed at an observer client 255 as described with reference to FIG. 2. In some embodiments, the observer GUI can enable the observer to watch a stream from respective users during an active test session or a replay of a test session as described with reference to FIGS. 4 and 5, respectively. In at least one embodiment, the observer GUI can enable an observer to search for clips, events, and annotations as described with reference to FIG. 5. Although two examples of the observer GUI are shown, other examples are possible. That is, the observer GUI can be customizable and different content can be displayed based on observer input.

In an embodiment, an observer GUI 260 can display user test sessions 605, application information 610, coordinator information 615, and user test session selector 620 during an active test session or during a replay of a test session. In some embodiments, application information 610 can display a name of the application 130 along with build information of the application 130. In some embodiments, coordinator information 615 can display contact information (e.g., name and email) of the coordinator. In at least one embodiment, user test session selector 620 displays options to change the view for the observer. For example, FIG. 6A illustrates an observer viewing nine (9) user streams simultaneously. The observer can interact with the user test session selector 620 to increase the number of user streams shown, decrease the number of user streams shown, or select specific users to focus on. For example, the observer can select to view six (6) user test sessions 605 or twelve (12) user test sessions 605 via the user test selector 605. In some embodiments, the observer could select user test session 605-a to focus on-e.g., the user test session 605-a can be displayed full screen for the observer while the remaining user test session 605 are hidden from view. In some embodiments, the user test session selector 620 can also display information about the user. For example, if the observer selects a first user, the user test session selector can display information associated with the first user-e.g., gameplay experience, competitiveness, etc. Accordingly, the observer can customize their stream (e.g., the content they are watching) to observe the aspects they would like to during a test session. In an embodiment, the observer can hide or disable any of the user test sessions 605, application information 610, coordinator information 615, and user test selector 620. For example, the observer can minimize the application information 610, the coordinator information 615, the user test session selector 620 to focus more on the user test sessions 605. In at least one embodiment, the observer can rearrange the user test sessions 605—e.g., switch user test session 605-i and 605-a.

FIG. 6B illustrates an example of a user test session 605 displayed on the observer GUI 260. For example, the user test session 605 can display an application stream 625. In some embodiments, application stream 625 can be gameplay associated with a respective user during the test session-e.g. associated with a first user at a first client device during the test session. In some embodiments, the application stream 625 can be of a spatial representation of gameplay events (e.g., a map) utilized in the software application 130. In some embodiments, the application stream 625 can display analytics of the respective user. In at least one embodiment, the user test session 605 can include a user webcam stream 630—e.g., a stream from the webcam source 240. Accordingly, the observer can observe a user’s reactions while the test session is ongoing. In at least one embodiment, the user test session 605 can include user input display 635. In some embodiments, the user input display 635 can display the user inputs as the user is interacting with the gameplay during the test session. For example, the user input display 635 can display a virtual controller that highlights buttons as a user presses them while interacting with the software application 130. In some embodiments, the user input display 635 can display a type of component the user is utilizing to interact with the software application 130-e.g., a controller, a mouse, a keyboard, etc. Accordingly, the observer can view the gameplay, the user’s reactions, and the user’s inputs during the test session. In some embodiments, the observer can customize the user test session 605 display. For example, the observer can decide to view the user webcam stream 630 as the main window and have the application stream 625 minimized-e.g., switch the position of the user webcam stream 630 and the application stream 625 illustrated in FIG. 6B. In at least one embodiment, the observer can view the user input display 635 as the main display. In some embodiments, the observer can disable or hide any of the application stream 625, user webcam stream 630, and user input display 635.

In an embodiment, the user test session 605 display can include stream controls 640. In at least one embodiment, stream controls 640 can display volume control buttons for each user test session 605—e.g., the observer can mute or increase the volume of a respective user test session 605. For example, the observer can mute or increase the volume of a user’s gameplay or microphone. In some embodiments, stream controls 640 can display options to hide or view the stream, along with additional options. In some embodiments, the stream controls 640 displayed can change when the observer focuses on one test session 605. For example, the stream controls 640 can display controls for pausing, rewinding, fast forwarding (for replayed streams) the stream of the user. In at least one embodiment, the stream controls 640 can display previews of gameplay at a respective time via a time bar-e.g., a preview of the stream at minute mark 5:34. In some embodiments, the stream controls 640 can enable an observer to annotate or mark the stream. For example, the observer can annotate the stream at a respective time and go back and watch the replay at a later time. In at least one embodiment, the stream controls 640 can enable the observer to create clips from the stream. In some embodiments, the stream controls 640 can enable the observer to share annotations or clips with other observers.

Other possible representations of the observer GUI 260 are possible. That is, the observer GUI 260 can display other information associated with the test session. For example, the observer GUI 260 can display notifications of events as described with reference to FIG. 2-e.g., indicate the first user is playing through an event marked by the developer. In an embodiment, the observer GUI 260 can display other observers that are actively observing the test session-e.g., display which observers are active and which observers are inactive. In an embodiment, the observer GUI 260 can display a timeline of events or annotations for a replay stream. In an embodiment, the observer GUI 260 can enable an observer to download clips from the test session. In some embodiments, the observer GUI 260 can enable an observer to set permissions for a clip from the test session-e.g., set permission levels to indicate who can access the clip later. In an embodiment, the observer GUI 260 can enable the observer to view a chronological representation of gameplay events or filter the chronological representation of the gameplay events. In some embodiments, the observer GUI 260 can enable the observer to customize the view to view all users, one user, a subset of users, etc. Accordingly, the observer GUI 260 can enable an observer to customize their display and focus on what they desire during a test session of a software application 130.

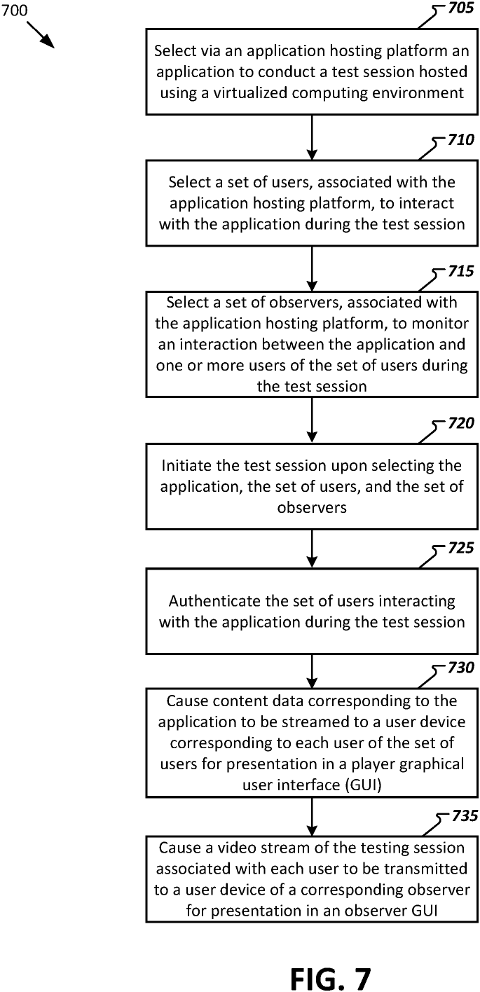

FIG. 7 illustrates a flow diagram of a method 700 for testing a software application in a cloud computing environment, according to some implementations. The method 700 can be performed by processing logic comprising hardware, software, firmware, or any combination thereof. In at least one embodiment, the method 700 is performed by computing environment 200 as described with reference to FIG. 2-e.g., performed by application hosting platform 102 as described with reference to FIG. 2. In some embodiments, the processing logic can associated with or otherwise located within the application hosting platform. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other diagrams illustrating a method for testing a software application in a cloud environment are possible.

At operation 705, the processing logic can select, via an application hosting platform, an application to conduct a test session, wherein the application is hosted using a virtualized computing environment instantiated using the application hosting platform for a test session. For example, a coordinator can utilize the processing device to select a software application registered with (or uploaded to) an application hosting platform to test before release of the software application. In one embodiment, selecting the application can include selecting a pre-release build of the application registered with the application hosting platform. In some embodiments the processing logic (e.g., via the application hosting platform) can select a build for the application from a pool of builds associated with the application hosted at the application hosting platform. In an embodiment, the processing logic can select an application not hosted at the virtualized computing environment. In such embodiments, the processing logic can indicate the application is not hosted at the application hosting platform and transmit instructions on registering the application with the application hosting platform. In at least one embodiment, the coordinator can be allowed, via the application hosting platform, to select a duration for the test session upon selecting the application-e.g., the coordinator can set a time and test session length upon selecting the application for the test session. In at least one embodiment, the coordinator can be allowed, via the application hosting platform, to modify the test session. For example, the modification includes at least one of modifying the set of users, modifying the set of observers, modifying the duration of the test session, modifying a build of the application, delete the session, etc. In at least one embodiment, information about the test session (e.g., the length, time, date, software application selected, etc.) can be stored at a server coupled with the processing device. In some embodiments, the server can also store a number of test sessions to be executed-e.g., store a list of all prior and upcoming test session as described with reference to FIG. 2. For example, the application hosting platform or processing logic can impltement, using the server coupled with the processing device, the number of test sessions to be executed. In at least one embodiment, the processing logic, via the application hosting platform executed using one or more processing device, can create a test session for the application hosted using the virtualized computing environment instantiated using the application hosting platform, where creating the test session includes operation 710 and operation 715—e.g., creating the test session includes selecting a set of users and a set of observers associated with the application hosting platform.

At operation 710, the processing logic, via the application hosting platform, can select a set of users associated with the application with the application hosting platform, to execute the application during the test session. That is, the coordinator can utilize the application hosting platform to select a group of users to test the game during the test session. In some embodiments, the set of users can be all users registered with the application hosting platform. In at least one embodiment, the coordinator can utilize the application hosting platform to select a user not associated with the application hosting platform. In such embodiments, the processing logic can send instructions to the user to register with the application hosting platform. That is, users not registered with the application hosting platform can be invited to a test session but the user must register with the application hosting platform before they can join the test session. In at least one embodiment, the coordinator can select the set of users, via the application hosting platform, based on characteristics of the user-e.g., gameplay experience, competitiveness/rank, types of games played, etc. In at least one embodiment, the processing logic can cause a notification to be presented in a player graphical user interface (GUI) for each user device corresponding to each user of the set of users to execute the application for the test session in response to selecting the set of users. That is, users can be notified they have been invited to a test session. In at least one embodiment, the player GUI can also enable the user to accept or decline the invitation-e.g., to RSVP.

At operation 715, the processing logic, via the application hosting platform, can select a set of observers associated with the application hosting platform, to monitor an interaction between the application and one or more users of the set of users during the test session. That is, the coordinator can utilize the application hosting platform to select a group of observers to test the software application during the test session. In some embodiments, the set of observers can be all users registered with the application hosting platform. In at least one embodiment, the coordinator can utilize the application hosting platform to select an observer not associated with the application hosting platform. In such embodiments, the processing logic can send instructions to the observer to register with the application hosting platform. That is, observers not registered with the application hosting platform can be invited to a test session but the observer must register with the application hosting platform before they can monitor the test session.

At operation 720, the processing logic, via the application hosting platform, can initiate the test session upon selecting the application, the set of users, and the set of observers. In at least one embodiment, the processing logic can initiate the test session at a time set by the coordinator.

At operation 725, the processing logic, via the application hosting platform, can authenticate the set of users interacting with the application during the test session. In at least one embodiment, the set of users can log into an account associated with the application hosting platform. In such embodiments, the application hosting platform can authenticate (e.g., verify) the user to access the pre-release build of the application. In at least one embodiment, the application hosting platform can authenticate the set of observers monitoring the test session. In at least one embodiment, the application hosting platform can verify or authenticate a token associated with the set of users or the set of observers. Accordingly, the application hosting platform can prevent unauthorized access to the software application and prevent a leak of the pre-release build of the software application.

At operation 730, the processing logic can cause content data corresponding to the application to be streamed to a user device corresponding to each user of the set of users for presentation in a player graphical user interface (GUI). In at least one embodiment, the processing logic can cause gameplay of the application to be streamed to each user device corresponding to each user of the set of users. In at least one embodiment, the player GUI enables the user to interact with the application-e.g., progress through a storyline of the application.

At operation 735, the processing logic can cause a video stream of the test session associated with each user from the set of users to be transmitted to a user device of a corresponding observer from the set of observers for presentation in an observer GUI. In at least one embodiment, the video stream reflects interactions of the user (e.g., of at least one user) with the content of the application. In one embodiment, the processing logic can cause the video stream of the test session associated with two or more users (e.g., all users) of the set of users to be streamed to the user device of the corresponding observer from the set of observers for presentation in the observer GUI. That is, the observer can customize their display and switch from monitoring one user to all users of the set of users as described with reference to FIG. 6. In at least on embodiment, the processing logic can receive the user input captured for each user from the set of users interacting with the content of the application-e.g., receive information specifying which buttons the user is pressing on a controller while playing the application. In at least one embodiment, the processing logic can cause the user input to be streamed to the user device of the corresponding observer from the set of observers for presentation in the observer GUI-e.g., the user inputs can be displayed on the observer GUI as described with reference to FIG. 6. In least one embodiment, the user device can include a webcam (e.g., webcam source 240). In such examples, the processing logic can receive a recording of each user from the set of users (e.g., a recording created using a webcam of each user device of each user from the set of users) and cause the recording of each user from the set of users to be streamed to the user device of the corresponding observer from the set of observers for presentation in the observer GUI-e.g., display the webcam feed as described with reference to FIG. 6. In some embodiments, the user can be notified of the recording-e.g., the user can be asked to consent to the recording, monitoring, or other permissions. In at least one embodiment, the observer can request test session information as described with reference to FIG. 3. In such embodiments, the processing logic, via the application hosting platform, can cause information associated with the test session to be provided to at least one observer of the set of observers, where the information includes at least one of the set of users (e.g., contact information, information regarding user’s experience, etc.) or a build of the application to be presented in the observer GUI for the observer of the set of observers. In at least one embodiment, the observers can annotate the stream of the test session as described with reference to FIG. 4. For example, the observer can annotate the stream to flag certain events or place a bookmark on a time stamp in the stream they would like to return while replaying the test session. In such examples, the processing logic can detect observer input, via the observer GUI at the use device of the corresponding observer from the set of observers, during a period of the video stream of the test session and store, at a database, an indication of the period during which the observer input is detected in response to detecting the observer input-e.g., the database can store the annotations and present them to the observer when the observer watches a replay of the video stream. In at least one embodiment, the processing logic can terminate the test session after the duration-e.g., after the time indicated by the coordinator has expired.

In at least one embodiment, the processing logic can store, at the database, a recording of the video stream of the test session associated with the at least one user of the set of users after termination of the test session, where the database is accessible to the corresponding observer from the set of observers. That is, the processing logic can store footage of the test session video stream at a database that can be accessed after the test session is complete. In at least one embodiment, the processing logic can store the recording of the video stream of a test session associated with all users of the set of users. In at least one embodiment, the processing logic can allow the corresponding observer to access, via the observer GUI, the recording of the video stream of the test session after termination of the test session. In at least one embodiment, the processing logic can enable the observer to search through the video stream of the test session-e.g., search for clips, annotations, events, etc.

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, XeonTM, Itanium®, XScaleTM and/or StrongARMTM, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS’ operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor’s data bus for performing operations on packed data, which may eliminate need to transfer smaller units of data across processor’s data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interfaces 825, a serial expansion port 827, such as Universal Serial Bus (“USB”), and a network controller 834, which may include in some embodiments, a data processing unit. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Such components may be used to generate synthetic data imitating failure cases in a network training process, which may help to improve performance of the network while limiting the amount of synthetic data to avoid overfitting.

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, system 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 936, and a touch pad 930 may be communicatively coupled to EC 935. In at least one embodiment, speaker 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Such components may be used to generate synthetic data imitating failure cases in a network training process, which may help to improve performance of the network while limiting the amount of synthetic data to avoid overfitting.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system’s registers and/or memories into other data similarly represented as physical quantities within computing system’s memories, registers or other such information storage, transmission or display devices.

In a similar manner, the term “processor” may refer to any device or portion of a device that processes electronic data from registers and/or memory and transform that electronic data into other electronic data that may be stored in registers and/or memory. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
selecting, via an application hosting platform executed using a processing device, an application to conduct a test session, wherein the application is hosted using a virtualized computing environment instantiated using the application hosting platform;
selecting, via the application hosting platform, a set of users associated with the application hosting platform to interact with the application during the test session;
selecting, via the application hosting platform, a set of observers associated with the application hosting platform to monitor an interaction between the application and one or more users of the set of users during the test session;
initiating, via the application hosting platform, the test session upon selecting the application, the set of users, and the set of observers;
authenticating, via the application hosting platform, the set of users interacting with the application during the test session;
causing content data corresponding to the application to be streamed to a user device corresponding to each user of the set of users for presentation in a player graphical user interface (GUI); and
causing a video stream of the test session associated with each user from the set of users to be transmitted to a user device of a corresponding observer from the set of observers for presentation in an observer GUI, the video stream reflecting interactions of the user with the content of the application.

2. The method of claim 1, wherein causing the video stream of the test session to be transmitted further comprises:
receiving user input captured for each user from the set of users interacting with the content of the application; and
causing the user input to be transmitted to the user device of the corresponding observer from the set of observers for presentation in the observer GUI.

3. The method of claim 1, wherein causing the video stream of the test session to be transmitted further comprises:
receiving a recording of each user from the set of users, wherein the recording is created using a webcam of each user device of each user from the set of users; and
causing the recording of each user from the set of users to be transmitted to the user device of the corresponding observer from the set of observers for presentation in the observer GUI.

4. The method of claim 1, further comprising:
causing a video stream of the test session associated with two or more users of the set of users to be transmitted to the user device of the corresponding observer from the set of observers for presentation in the observer GUI.

5. The method of claim 1, further comprising:
storing, at a data store, a recording of the video stream of the test session associated with the user of the set of users after termination of the test session.

6. The method of claim 5, further comprising:
allowing the corresponding observer to access, via the observer GUI, the recording of the video stream of the test session after termination of the test session.

7. The method of claim 1, further comprising:
detecting observer input, via the observer GUI at the user device of the corresponding observer from the set of observers, during a period of the video stream of the test session; and
storing, at a data store, an indication of the period during which the observer input is detected in response to the detecting the observer input.

8. The method of claim 1, further comprising:
selecting, via the application hosting platform, a duration for the test session upon selecting the application; and
terminating, via the application hosting platform, the test session after the duration expires.

9. The method of claim 1, further comprising:
modifying, via the application hosting platform, the test session, wherein the modification comprises at least one of modifying the set of users, modifying the set of observers, modifying a duration of the test session, or modifying a build of the application.

10. The method of claim 1, further comprising:
implementing, using a server coupled with the processing device, a number of test sessions to be executed.

11. The method of claim 1, further comprising:
causing, via the application hosting platform, information associated with the test session to be provided to at least one observer of the set of observers, wherein the information comprises at least one of the set of users or a build of the application to be presented in the observer GUI for the observer of the set of observer.

12. The method of claim 1, further comprising:
causing a notification to be presented in the player GUI for each user device corresponding to each user of the set of users to execute the application for the test session in response to selecting the set of users.

13. A system, comprising:
one or more processing units, wherein the one or processing units are to perform operations comprising:
select an application hosted at a virtualized computing environment implemented using an application hosting platform for a test session;
select a set of users associated with the application hosting platform, to execute the application during the test session;
select a set of observers associated with the application hosting platform, to monitor one or more users of the set of users during the test session;
initiate the test session upon selecting the application, the set of users, and the set of observers;
authenticate the set of users interacting with the application during the test session;
cause content data corresponding to the application to be streamed to a user device of each user from the set of users for presentation in a player graphical user interface (GUI); and
cause a video stream of the test session associated with at least one user of the set of users to be transmitted to a user device of a corresponding observer from the set of observers for presentation in an observer GUI, the video stream reflecting interactions of the at least one user with the content of the application.

14. The system of claim 13, wherein to cause the video stream of the test session to be transmitted, the one or more processing units are further to:
receive user input captured for at least one from the set of users interacting with the content of the application; and
cause the user input to be transmitted to the user device of the corresponding observer from the set of observers for presentation in the observer GUI.

15. The system of claim 13, wherein to cause the video stream of the test session to be transmitted, the one or more processing units are further to:
receive a recording of at least one user from the set of users, wherein the recording is created using a webcam of at least one user device of the at least one user; and
cause the recording of the at least one user from the set of users to be transmitted to the user device of the corresponding observer from the set of observers for presentation in the observer GUI.

16. The system of claim 13, wherein the one or more processing units are further to:
causing the video stream of the test session associated with two or more users of the set of users to be transmitted to the user device of the corresponding observer from the set of observers for presentation in the observer GUI.

17. The system of claim 13, wherein the one or more processing units are further to:
store, at a data store, a recording of the video stream of the test session associated with the at least one user of the set of users after termination of the test session.

18. The system of claim 17, wherein the one or more processing units are further to:
allow the corresponding observer to access, via the observer GUI, the recording of the video stream of the test session after termination of the test session.

19. The system of claim 13, wherein the one or more processing units are further to:
select, via the application hosting platform, a duration for the test session upon selecting the application; and
terminate, via the application hosting platform, the test session after the duration.

20. A non-transitory computer-readable medium storing instructions thereon, wherein the instructions, when executed by a processing device, cause the processing device to:
create, via an application hosting platform executed using one or more processing devices, a test session for an application hosted using a virtualized computing environment instantiated using the application hosting platform, wherein creating the test session comprises selecting a set of users and a set of observers associated with the application hosting platform;
cause a video stream of the test session associated with at least one user of the set of users to be streamed to a user device of a corresponding observer from the set of observers for presentation in an observer GUI, the video stream reflecting interactions of the at least one user with the content of the application; and
storing, at a data store, a recording of the video stream of the test session associated with the at least one user of the set of users, wherein the recording of the video stream of the test session is accessible to the corresponding observer of the set of observers after termination of the test session.
